(19) United States
(12) Patent Application Publication
(10) Pub. No.: US 2021/0041334 A1
(43) Pub. Date: Feb. 11, 2021

(54) TEST APPARATUS AND METHOD FOR TESTING A LOAD CHANGE

(71) Applicant: MAXIMATOR GMBH, Nordhausen (DE)

(72) Inventors: Robert ADLER, Wien (AT); Georg FAHRTHOFER, Wien (AT); Sarah GRUBER, Wien (AT); Christoph NAGL, Wien (AT); Markus RASCH, Wien (AT); Markus STEPHAN, Wien (AT)

(21) Appl. No.: 16/966,772

(22) PCT Filed: Jan. 31, 2019
(86) PCT No.: PCT/EP2019/052309

§ 371 Date: Jul. 31, 2020

(30) Foreign Application Priority Data
Jan. 31, 2018 (EP) 18154376.0

(51) Int. Cl. G01N 3/12; G01N 3/06; F17C 5/06

(52) U.S. Cl. CPC G01N 3/12; F17C 2270/0178; F17C 5/06; G01N 2203/0075; G01N 2203/0044; G01N 2203/0222; G01N 2203/0232; G01N 2203/0617; F17C 2221/011; F17C 2221/012; F17C 2221/014; F17C 2221/017; F17C 2221/031; F17C 2221/033; F17C 2223/0123; F17C 2223/036; F17C 2250/0443; F17C 2250/0469; G01N 3/066

(57) ABSTRACT

The invention relates to a test apparatus and a method for testing a load change of a compressed-gas accumulator, said method comprising the steps of: i. arranging the compressed-gas accumulator to be tested inside a test container; ii. increasing the pressure of a compressed gas in the compressed-gas accumulator to a test pressure; iii. measuring the elastic deformation of the compressed-gas accumulator, which is caused by the test pressure of the compressed gas; iv. Increasing the pressure of a pressure medium in the test container such that the elastic deformation of the compressed-gas accumulator is reduced by the pressure of the pressure medium on the compressed-gas accumulator; v. lowering the pressure of the pressure medium in the test container; and vi. repeating steps iii. to v.

The invention relates to a method and a test apparatus for testing a load change of a compressed-gas accumulator.

As a result of the considerable potential hazard, compressed-gas accumulators are subject to comprehensive destructive and non-destructive tests in which the test specimens are acted upon by the pressure medium from inside to test pressure. In the prior art, the compressed-gas accumulator is then relieved of pressure by releasing the pressure medium. One filling and one pressure-relief process is carried out per test cycle. Strain gauges can be used in the load change testing. In the case of strain gauges, use is made of the fact that the resistance of the strain gauge changes during a length change of the associated test specimen. Thus, mechanical stresses can be detected.

CN 101 881 714 A discloses a test apparatus for pressure testing of gas bottles, wherein an external measurement method with a variable volume is used. In this case, the gas bottle is located in a test pressure container, wherein the gas bottle and the test pressure container are filled with a medium such as, for example, water via lines. The medium is brought to a higher pressure by means of a pump and fed into the gas bottle, with the result that the gas bottle expands. In order that the pressure in the intermediate space between the test pressure container and the gas bottle remains constant, the medium located in this intermediate space expands into a cylinder connected to the intermediate space by pressing away a piston in the cylinder.

Further test systems for gas containers are described in CN 101 403 669 A and in GB 2 185 581 A.

A disadvantage however is that the load change testing of compressed-gas accumulators so far can take a relatively long time depending on accumulator volume, pressure and medium. As a result of the thermodynamic specifications of the respective medium and the permissible usage temperatures of the compressed-gas accumulator, a minimum duration is obtained for each test cycle. Furthermore, in many cases, a test temperature is prescribed in a certain tolerance range. In this case, the expenditure and the test cycle time increase significantly.

In particular in the case of series components with high demands on pressure and accumulator volume such as, for example, in the case of compressed-gas accumulators of vehicles, in particular hydrogen vehicles, increasing production numbers result in an increase in the tests to be carried out. A reduction in the time expenditure for the test cycle is therefore desirable.

It is accordingly the object of the present invention to ameliorate or eliminate at least some disadvantages of the prior art. The aim of the invention in particular is to shorten the time for carrying out the load change testing and make it easier to maintain the test conditions.

In the method according to the invention, at least the following steps are carried out:
i. arranging the compressed-gas accumulator to be tested inside a test container;
ii. increasing the pressure of a compressed gas in the compressed-gas accumulator to a test pressure;
iii. measuring an elastic deformation of the compressed-gas accumulator which is caused by the test pressure of the compressed gas;
iv. increasing the pressure of a pressure medium in the test container so that the elastic deformation of the compressed-gas accumulator is reduced by the pressure of the pressure medium on the compressed-gas accumulator;
v. lowering the pressure of the pressure medium (2) in the test container;
vi. repeating steps iii. to v.

Accordingly, in order to reduce the elastic deformation of the compressed-gas accumulator during the load change, the external pressure on the compressed-gas accumulator due to the pressure medium is increased. Advantageously the internal pressure exerted by the compressed gas on the compressed-gas accumulator can be compensated by the external pressure exerted by the pressure medium on the compressed-gas accumulator. In this method it is therefore not necessary to lower the test pressure of the compressed gas during the load change testing. Accordingly, steps iii. to v. of the previously described method can be carried out at the same test pressure of the compressed gas. Advantageously the duration of the load change testing can thus be reduced substantially. As a result of the arrangement of the test container in the preferably liquid pressure medium, temperature influences and other external disturbance variables are additionally reduced considerably. Thus, more precise load change tests can be carried out in a shorter time.

In order to precisely prepare the load change, it is favourable if the pressure of the pressure medium in the test container is increased until a substantially complete regression of the elastic deformation of the compressed-gas accumulator is measured. In this embodiment, the regression of the elastic deformation due to the pressure of the pressure medium is therefore measured directly in order to determine the end of the load change.

In an alternative embodiment which is particularly simple in terms of measurement technology, the pressure of the pressure medium in the test container is increased until the pressure of the pressure medium in the test container substantially corresponds to the test pressure of the compressed gas in the compressed-gas accumulator. In this embodiment, the initial state of the test container is approximated by measuring the pressure of the pressure medium in the test container during the increase in pressure and comparing this continuously with the test pressure of the compressed gas in the compressed-gas accumulator. When the pressure of the pressure medium in the test container reaches the test pressure of the compressed gas in the compressed-gas accumulator, the load change is considered to be completed. Thereafter, the pressure of the pressure medium in the test container can be lowered again in order to initiate the next load change.

With regard to a uniform pressurization of the test container during the load change testing, it is favourable if the compressed-gas accumulator to be tested in the test container is surrounded on all sides by the pressure medium. Accordingly, the outer side of the test container can be uniformly exposed to the pressure of the pressure medium. Thus, the compressed-gas accumulator can be exposed to the same loads as in conventional load change tests with alternate filling and emptying of the compressed-gas accumulator without however needing to accept the accompanying disadvantages, in particular with regard to the time expenditure.

In order to exactly determine the stretching state of the compressed-gas accumulator, it is advantageous if the elastic deformation of the compressed-gas accumulator is detected by means of at least one, preferably by means of at least two, particularly preferably by means of at least three strain gauges on the compressed-gas accumulator. Strain gauges are measuring elements for detecting stretching and compressing deformations. During deformations a change in the electrical resistance is detected. The at least one strain gauge is arranged on the wall of the compressed-gas accumulator, for example, is adhesively bonded.

For a rough estimate of the stretching state of the compressed-gas accumulator, it is furthermore favourable if a flow volume of the pressure medium flowing into the test container and/or a flow volume of the pressure medium flowing out of the test container is measured in order to determine a volume change of the compressed-gas accumulator from the inflowing or outflowing flow volume of the pressure medium. Accordingly, the determination of the flow volume allows a (rough) estimate of the volume change of the compressed-gas accumulator as a result of the compressed gas.

In this embodiment, preferably the further steps are carried out:
comparing the volume change of the compressed-gas accumulator with a reference value and
determining an error of the compressed-gas accumulator when the volume change of the compressed-gas accumulator exceeds the reference value.

For precise pressurization of the compressed-gas accumulator from outside, the pressure medium is preferably substantially incompressible wherein preferably water, a liquid having a water content of more than 5 volume percent and less than 100 volume percent, in particular of 20 volume percent to 60 volume percent, or a hydraulic liquid is used as pressure medium.

In order to ensure the same conditions for the load change testing it is favourable if the temperature of the compressed-gas accumulator is adjusted by means of a temperature-control unit. Preferably the temperature of the pressure medium in the test container is adjusted. As a result, the desired temperature relationships can be maintained particularly precisely.

The previously described method for load change testing is particularly suitable for compressed-gas accumulators in which the test pressure of the compressed gas in the compressed-gas accumulator is from 5 bar to 2500 bar, in particular from 500 bar to 1800 bar, in particular from 900 bar to 1500 bar. Accordingly, the pressure of the pressure medium in the test container is raised to the same pressure value in order to compensate as far as possible for the resulting material stress of the compressed-gas accumulator due to the test pressure.

The test apparatus according to the invention for pressure testing of compressed-gas accumulators comprises at least the following components:
a compressed-gas accumulator to be tested;
a test container in which the compressed-gas accumulator to be tested is accommodated;
a compressed gas supply line for filling the compressed-gas accumulator with compressed gas;
a pressure medium supply line for filling the test container with a pressure medium;
a measuring element for measuring an elastic deformation of the compressed-gas accumulator;
a device for increasing the pressure of the pressure medium in the test container.

The advantages and effects of this test device are obtained from the previously described method so that repetitions should be dispensed with.

The device for increasing the pressure of the pressure medium in the test container preferably comprises a high-pressure pump which is available in various embodiments in the prior art.

In order to achieve the same test conditions, the test apparatus preferably has a temperature-control unit for adjusting a temperature of the compressed-gas accumulator to be tested. Preferably the temperature-control unit has a heating and/or cooling element for heating and/or cooling the pressure medium in the test container. For example, a medium-conducting line can be provided as heating and/or cooling element which guides through the interior of the test container.

In order to enable the inflow and outflow of the pressure medium from the test container according to the phase of the load change, in a preferred embodiment, the test apparatus has a first pressure medium discharge line for discharging the pressure medium from the test container and a valve device which can be switched between an open position and a closed position in the first pressure medium discharge line.

According to a further preferred embodiment, a flow measuring device for determining the flow volume of the pressure medium flowing into the test container and/or flowing out from the test container is additionally provided.

According to a preferred embodiment, the device for increasing the pressure of the pressure medium in the test container comprises a drive, a piston connected to the drive and a housing with an interior connected to the test container, wherein the piston is displaceable in the interior of the housing with a stroke in order to increase or decrease the pressure of the pressure medium in the test container (depending on the direction of movement of the piston).

In order to complete the load change testing, the test apparatus preferably comprises
a second pressure medium discharge line for discharging the pressure medium from the test container;
a further valve device which can be switched between an open position and a closed position in the second pressure medium discharge line; and
a pump device in the second pressure medium discharge line for pumping the pressure medium from the test container. The pump device preferably comprises a low-pressure pump.

The invention is explained in further detail hereinafter with reference to an exemplary embodiment shown in the drawing.

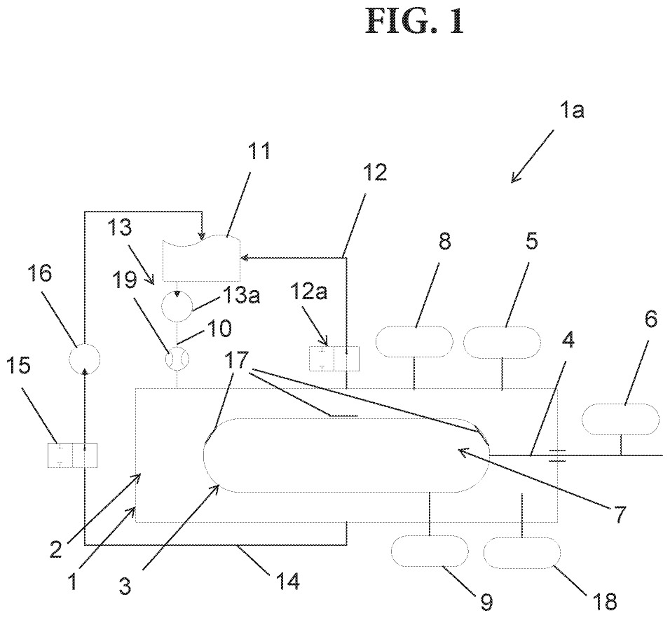

FIG. 1 shows a functional diagram of a test apparatus for testing a load change of a compressed-gas accumulator.

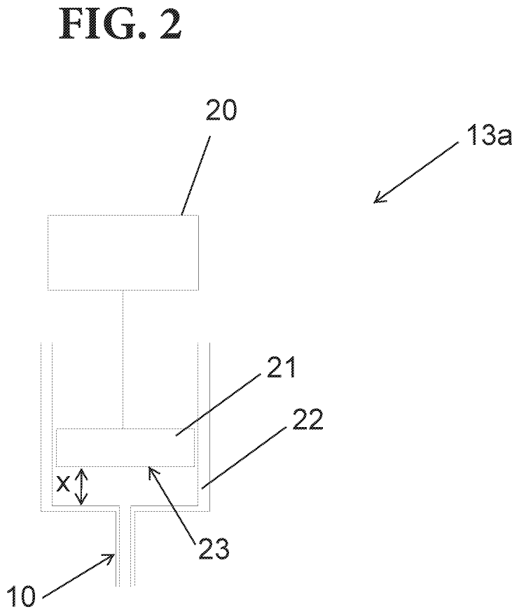

FIG. 2 shows a preferred embodiment of a high-pressure pump for the test apparatus according to FIG. 1.

FIG. 1 shows an embodiment of a test apparatus 1a for carrying out load change tests. The test apparatus 1a comprises a pressure-tight test container 1 which can be filled under pressure with a substantially incompressible liquid pressure medium 2. A compressed-gas accumulator 3 to be tested is accommodated inside the test container 1. The pressure-tight test container 1 can be opened and closed so that the compressed-gas accumulator 3 to be tested can be inserted and removed. The compressed-gas accumulator 3 contains a compressed gas 7. The pressure medium 2 can be water, a liquid having a water fraction of 5% to less than 100%, in particular from 20% to 60% or a mineral-oil-based hydraulic liquid. The compressed gas 7 is preferably a gaseous fluid, in particular an inert gas or combustion gas, in particular nitrogen, helium, natural gas, in particular hydrogen, furthermore compressed air or oxygen. The pressure-tight test container 1 is designed to a pressure of 5 bar to 2500 bar, preferably from 500 bar to 1800 bar, in particular from 900 bar to 1500 bar. The test pressure in the compressed-gas accumulator 3 is from 5 bar to 2500 bar, preferably from 500 bar to 1800 bar, in particular from 900 bar to 1500 bar.

As is further apparent from FIG. 1, the test apparatus 1 comprises a compressed gas supply line 4 which leads through the pressure-tight container 1 to the compressed-gas accumulator 3, by means of which the pressure of the compressed gas 7 in the compressed-gas accumulator 3 can be adjusted. A first pressure measuring device 5 determines the pressure of the pressure medium 2 in the pressure-tight test container 1. A second pressure measuring device 6 determines the pressure of the compressed gas 7 in the compressed-gas accumulator 3. A first temperature measuring device 8 determines the temperature of the pressure medium 2 in the pressure-tight test container 1. A second temperature measuring device 9 determines the temperature of the compressed-gas accumulator 3. A pressure medium supply line 10 connects the pressure-tight test container 1 to a pressure-medium accumulator 11. Furthermore a first pressure-medium discharge line 12 is provided which connects the test container 1 to the pressure medium accumulator 11. A first valve device 12a is provided in the first pressure-medium discharge line 12 by means of which the return of the pressure medium 2 from the test container 1 into the pressure-medium accumulator 11 can be selectively released and interrupted. In addition, the test container can therewith be ventilated. The pressure-medium accumulator 11 contains the pressure medium 2 and is at atmospheric pressure. The test apparatus 1a additionally has, in the pressure-medium supply line 10, a device 13 for increasing the pressure of the pressure medium 2 in the test container 1. In the embodiment shown a high-pressure pump 13a is provided as device 13, by means of which the pressure of the pressure medium 2 in the test container 1 can be increased. A second pressure-medium discharge line 14 connects the test container 1 to the pressure-medium accumulator 11, wherein the pressure-medium discharge line 14 can be selectively released and interrupted by a further valve device 15. A pump device with a lower-pressure pump 16 makes it possible to empty the pressure-tight test container 1, by guiding the pressure medium 2 into the pressure-medium accumulator 11.

As is further apparent from FIG. 1, in the embodiment shown the compressed-gas accumulator 3 is provided with respectively one measuring element 17 at at least one position, but preferably at three to five positions at a distance from one another, preferably at precisely three positions, by means of which local length variations of the wall of the compressed-gas accumulator 3 are detected. The measuring element 17 is preferably designed as a strain gauge for detecting length variations. That measured variable which is determined at the compressed-gas accumulator 3 in the pressure-less state is used as the reference value for the length variation. A temperature-control unit 18 allows the temperature of the compressed-gas accumulator 3 to be influenced by heating and/or cooling the pressure medium 2 in the test container 1. A flow measuring device 19 measures the flow volume of the pressure medium 2 conveyed into the test container 1. The measured value for the flow volume of the pressure medium 2 can be compared with a reference value in order to determine an atypical behaviour of the compressed-gas accumulator 3 to be tested.

For the purpose of the load change testing, the compressed-gas accumulator 3 is arranged in the interior of the pressure-tight test container 1 which is filled with the pressure medium. The compressed-gas accumulator 3 is pressurized from inside with the compressed gas 7 until the compressed gas 7 reaches the desired test pressure in the compressed-gas accumulator 3. The pressurization of the compressed-gas accumulator 3 brings about an elastic deformation of the wall of the compressed-gas accumulator 3 which is detected using the measuring elements 17. The length variation is greater, the higher the pressure difference between pressure medium 2 and compressed gas 7. In the pressure-less state of the pressure medium 2 (i.e. in the switched-off state of the high-pressure pump 13a), the length variation of the compressed-gas accumulator 3 reaches a maximum value. In the embodiment shown the pressure of the incompressible pressure medium 2 is then increased so that the compressed-gas accumulator 3 is exposed to (additional) pressure on the surface. For this purpose the valve device 12a in the first pressure-medium discharge line 12 and the further valve device 15 in the second pressure-medium discharge line 14 are each switched into the closed position whilst the high-pressure pump 13a is active so that the pressure of the pressure medium 2 inside the test container 1 is continuously increased. As a result of the pressure exerted from outside on the compressed-gas accumulator 3, the length variation is reduced compared with the maximum value wherein the measured variables of the measuring elements 17 are approximated as closely as possible to the previously determined original state. In practice however, due to measurement errors, manufacturing tolerances etc., deviations are unavoidable, which for example are less than 20%, in particular less than 10%, preferably less than 3%. In order to relieve the pressure, the valve device 12a is opened with the result that the pressure value of the first pressure measuring device 5 is reduced to atmospheric pressure. According to the desired number of cycles, the process of raising and releasing the pressure is repeated many times, for example, more than 100 times, in particular more than 500 times. After the end of the load change testing, the further valve device 15 is opened. By means of the low-pressure pump 16 the pressure medium 2 is pumped out from the pressure-tight test container 1 into the media accumulator 11. The compressed-gas accumulator 3 can then be removed from the emptied test container 1 whereupon the test apparatus 1a is available for the load change testing of the next compressed-gas accumulator 3.

In a further embodiment, the pressure of the pressure medium 2 is increased for regression of the elastic deformation of the compressed-gas accumulator 3 until the pressure value at the first pressure-measuring device 5 substantially corresponds to the test pressure at the second pressure measuring device 6.

FIG. 2 shows a particular configuration of the high-pressure pump 13a. The high-pressure pump 13a has a drive 20. This drive 20 acts on a piston 21 which, in the embodiment shown, is connected via the pressure-medium supply line 10 to the test container 1. The high-pressure pump 13a can be installed directly at the test container 1. The drive 20 is in particular designed as a mechanical drive, as a pneumatic, electrical or hydraulic drive. The piston 21 is arranged movably in the interior of the housing 22. When the piston 21 is displaced by a stroke x, a piston surface 23 of the piston 21 acts on the working or pressure medium 2 in the test container 1. The displacement volume of the piston 21 is formed by the product of piston area 23 and stroke x. In the cyclic load change testing of the compressed-gas accumulator 3, the required volume change for the compressed-gas accumulator 3 is brought about by the variation of the stroke x. When the stroke x is reduced, the pressure of the pressure medium 2 in the test container 1 increases accordingly, with the result that the mechanical stresses in the compressed-gas accumulator 3 are reduced. When the stroke x of the piston 21 is increased in the next step, the external pressure on the compressed-gas accumulator 3 decreases so that the mechanical stresses in the compressed-gas accumulator 3 are increased.

### EXEMPLARY EMBODIMENT

In one exemplary embodiment, a pressure container 3 in the form of a hydrogen tank for a motor vehicle is to be loaded with hydrogen over 1000 cycles with a load fluctuation range from 0 to 1000 bar. Accordingly, the pressure of the hydrogen is increased to the test pressure of 1000 bar. The pressure exerted on the compressed-gas accumulator 3 by the pressure medium 2 from outside is then increased until the length variation at the compressed-gas accumulator 3 yields a minimum. The pressure from the pressure medium 2 on the compressed-gas accumulator 3 is then reduced to atmospheric pressure. This process is repeated 1000 times.

This test method can be used, for example, in the production of hydrogen vehicle tanks, wherein for example every 200th hydrogen vehicle tank is tested with 1000 full load changes. The total test time can in this case be reduced substantially compared with the prior art.

The test apparatus 1 is furthermore particularly well suited for carrying out burst tests. In this case, the pressure in the compressed-gas accumulator 3 is increased through the compressed-gas supply line 4 until the compressed-gas accumulator 3 bursts. The test container 1 with the pressure medium 2 serves as shielding in this case so that the safety is substantially increased.

1. Method for testing a load change of a compressed-gas accumulator comprising the steps:
i. arranging the compressed-gas accumulator to be tested inside a test container;
ii. increasing a pressure of a compressed gas in the compressed-gas accumulator to a test pressure;
iii. measuring an elastic deformation of the compressed-gas accumulator which is caused by the test pressure of the compressed gas;
iv. increasing the pressure of a pressure medium in the test container so that the elastic deformation of the compressed-gas accumulator is reduced by the pressure of the pressure medium on the compressed-gas accumulator;
v. lowering the pressure of the pressure medium in the test container;
vi. repeating steps iii. to v.

2. Method according to claim 1, wherein the pressure of the pressure medium in the test container is increased until a substantially complete regression of the elastic deformation of the compressed-gas accumulator is measured.

3. Method according to claim 1, wherein the pressure of the pressure medium in the test container is increased until the pressure of the pressure medium in the test container substantially corresponds to the test pressure of the compressed gas in the compressed-gas accumulator.

4. Method according to claim 3, wherein the compressed-gas accumulator to be tested in the test container is surrounded on all sides by the pressure medium.

5. Method according to claim 4, wherein the elastic deformation of the compressed-gas accumulator is detected by at least one strain gauge.

6. Method according to claim 5, wherein a flow volume of the pressure medium flowing into the test container and/or a flow volume of the pressure medium flowing out of the test container is measured in order to determine a volume change of the compressed-gas accumulator from the inflowing flow volume or the outflowing flow volume of the pressure medium.

7. Method according to claim 6, wherein the further steps:
comparing the volume change of the compressed-gas accumulator with a reference value;
determining an error of the compressed-gas accumulator when the volume change of the compressed-gas accumulator exceeds the reference value.

8. Method according to claim 7, wherein the pressure medium is substantially incompressible.

9. Method according to claim 8, wherein the temperature of the compressed-gas accumulator is adjusted by means of a temperature-control unit.

10. Method according to claim 9, wherein the test pressure of the compressed gas in the compressed-gas accumulator is from 5 bar to 2500 bar, in particular from 500 bar to 1800 bar, in particular from 900 bar to 1500 bar.

11. Test apparatus for pressure testing of compressed-gas accumulators comprising:
a compressed-gas accumulator to be tested;
a test container in which the compressed-gas accumulator to be tested is accommodated;
a compressed gas supply line for filling the compressed-gas accumulator with compressed gas;
a pressure medium supply line for filling the test container with a pressure medium;
a measuring element for measuring an elastic deformation of the compressed-gas accumulator;
a device for increasing a pressure of the pressure medium in the test container,
wherein a test pressure of the compressed gas in the compressed-gas accumulator is from 5 bar to 2500 bar, in particular from 500 bar to 1800 bar, in particular from 900 bar to 1500 bar.

12. Test apparatus according to claim 11, wherein
a first pressure medium discharge line for discharging the pressure medium from the test container;
a valve device which can be switched between an open position and a closed position in the first pressure medium discharge line.

13. Test apparatus according to claim 11, wherein
a flow measuring device for determining a flow volume of the pressure medium flowing into the test container and/or flowing out from the test container (1).

14. Test apparatus according to claim 11, wherein the device for increasing the pressure of the pressure medium in the test container comprises a drive, a piston connected to the drive and a housing with an interior connected to the test container, wherein the piston is displaceable in the interior of the housing with a stroke in order to increase or decrease the pressure of the pressure medium in the test container.

15. Test apparatus according to claim 11, wherein
a second pressure medium discharge line for discharging the pressure medium from the test container;
a further valve device which can be switched between an open position and a closed position in the second pressure medium discharge line;
a pump device in the second pressure medium discharge line for pumping the pressure medium from the test container.
